(19) United States
(12) Patent Application Publication
(10) Pub. No.: US 2007/0146264 A1
(43) Pub. Date: Jun. 28, 2007

(54) Liquid crystal display and driving method thereof

(76) Inventor: Kyung Ho Choi, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/646,335

(22) Filed: Dec. 28, 2006

(30) Foreign Application Priority Data
Dec. 28, 2005 (KR) 10-2005-0131494

(51) Int. Cl. G09G 3/36

(52) U.S. Cl. 345/87

(57) ABSTRACT

A liquid crystal display (LCD) including a LCD panel having optically compensated birefringent (OCB) mode liquid crystal (LC) cells, each OCB mode LC cell being associated with a gate line and a data line, and a LCD panel driver for applying an impulse voltage for a predetermined period within a first frame period when a pixel signal is supplied to the OCB mode LC cell, wherein the impulse voltage is equal to or greater than a black voltage for the OCB mode LC, and, after the predetermine period, for applying the pixel signal to the OCB mode LC.

### BACKGROUND OF THE INVENTION

1. Field of the Invention

The present invention relates to a liquid crystal display (LCD). More particularly, the present invention relates to an optically compensated birefringence (OCB) mode LCD, and a driving method thereof.

2. Description of the Related Art

A liquid crystal display (LCD) displays an image by controlling optical transmittance of liquid crystal (LC) cells in accordance with a video signal. An active matrix (AM) type LCD may include a switching element in each LC cell suitable for displaying a moving picture. A thin film transistor (TFT) is typically used as a switching element in the AM-LCD.

LCDs may provide many advantages over other display technologies, e.g., cathode ray tubes, such as being smaller, lighter, brighter, flatter, and longer lived. Therefore, LCDs have been widely used in personal computers, note-book computers, office automation equipment, e.g., printers, and portable apparatuses, e.g., mobile phones, beepers, etc.

An LCD typically uses a twisted nematic (TN) mode LC. The TN mode LC typically has a twist angle of 90°, and arrangement of the LC molecules is typically changed according to application of an electric field. The TN mode LC transmits light vibrating in a major-axis direction of LC compounds, and light vibrating in a vertical direction to the major-axis direction.

An anisotropic index of refraction, i.e., birefringence, means that a refractive index varies in accordance with different vibrating directions of light. The TN mode LC may have a narrow viewing angle and a slow response time due to the anisotropic index of refraction.

Also, it may be difficult to realize an acceptable moving picture using a conventional LCD, due to smears on the picture that may arise when a voltage applied to the LC, e.g., an image signal or a data voltage, is maintained for one frame period, and, then, a new voltage is applied to the next frame period, since a response time of the LC may lag by as much as one frame period during driving the conventional LCD.

### SUMMARY OF THE INVENTION

The present invention is therefore directed to an optically compensated birefringence (OCB) mode liquid crystal display (LCD) and driving method therefor, which substantially overcome one or more of the problems due to the limitations and disadvantages of the related art.

It is therefore a feature of an embodiment of the present invention to provide an OCB mode LCD having an improved optical transmittance of the OCB mode LCD itself.

It is another feature of an embodiment of the present invention to provide an OCB mode LCD having an improved white bend state stability.

It is yet another feature of an embodiment of the present invention to provide a small OCB mode LCD, e.g., for use in mobile devices, etc.

It is still another feature of an embodiment of the present invention to provide an OCB mode LCD using an impulse driving method for applying a high voltage during a predetermined time out of one frame period, followed by applying a corresponding data signal.

At least one of the above and other features and advantages of the present invention may be realized by providing a liquid crystal display (LCD), including a LCD panel including a plurality of optically compensated birefringence (OCB) mode liquid crystal (LC) cells, each OCB mode LC cell being associated with a gate line and a data line, and a LCD panel driver for applying an impulse voltage for a predetermined period within a first frame period when a pixel signal is supplied to the OCB mode LC cell, the impulse voltage being equal to or greater than a black voltage for the OCB mode LC, and for applying, after the predetermine period, the pixel signal to the OCB mode LC.

The LCD panel driver may include a gate driver for sequentially driving gate lines, and a data driver for applying the impulse voltage for the predetermined period within the first frame period and applying the pixel signal, after the predetermined period, to data lines. The data driver and the gate driver may be formed in a form of chip-on-panel composed of one integrated circuit. The LCD may be a small OCB mode LCD provided in a mobile device. The predetermined period may be about 10˜20% of the first frame period. The impulse voltage may be about 5˜8V or higher. A critical voltage of the OCB mode LC cell may be about zero.

At least one of the above and other features and advantages of the present invention may be realized by providing a method for driving a liquid crystal display (LCD) panel having a plurality of OCB mode liquid crystal (LC) cells, each OCB mode LC cell being associated with a gate line and a data line, the method including applying an impulse voltage for a predetermined period within a first frame period when a pixel signal is supplied to the OCB mode LC cell, the impulse voltage being equal to or greater than a black voltage for the OCB mode LC, and applying, after the predetermined period, the pixel signal.

The method may further include sequentially driving gate lines via a gate driver, wherein applying the impulse voltage for the predetermined period within the first frame period and applying the pixel signal may be to data lines via a data driver. The data driver and the gate driver may be formed as a chip-on-panel composed of one integrated circuit.

The predetermined period may be about 10˜20% of the first frame.

The impulse voltage may be at least about 5˜8V. A critical voltage of the OCB mode LC cell may be about zero

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a perspective schematic view of an OCB mode LCD;

FIG. 2A to FIG. 2C illustrate alignment of an OCB mode LC depending on a voltage applied to the OCB mode LCD shown in FIG. 1;

FIG. 3 illustrates a diagram of an optical transmittance depending on a voltage applied to the OCB mode LCD shown in FIG. 1;

FIG. 4 illustrates a block diagram of a configuration of an OCB mode LCD according to an embodiment of the present invention;

FIG. 5A illustrates a driving method for the OCB mode LCD of FIG. 4;

FIG. 5B illustrates a relationship between an amplitude of an impulse voltage used in the driving method of FIG. 5A and a transition voltage; and

FIG. 5C illustrates increased transmittance that may be realized using the driving method of FIG. 5A.

### DETAILED DESCRIPTION OF THE INVENTION

Korean Patent Application No. 10-2005-0131494, filed on Dec. 28, 2005, in the Korean Intellectual Property Office, and entitled: “Liquid Crystal Display and Driving Method Thereof,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

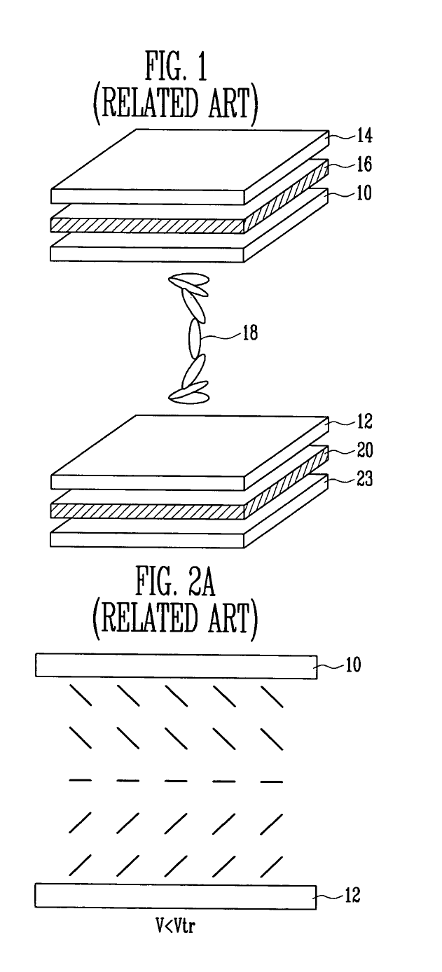

FIG. 1 illustrates a perspective schematic view of an optically compensated birefringence (OCB) mode liquid crystal display (LCD).

Referring to FIG. 1, the OCB mode LCD may include a first substrate 10, a second substrate 12, and an OCB mode liquid crystal (LC) 18. The first substrate may include a color filter array and an upper alignment layer. The second substrate 12 may include a thin film transistor (TFT) array, a pixel electrode and a lower alignment layer. The OCB mode LC 18 may fill a predetermined gap between the first substrate 10 and the second substrate 12. The OCB mode LCD may further include an upper polarizer 14, arranged at a surface of the first substrate 10 opposite the OCB mode LC 18, and a lower polarizer 23, arranged at a surface of the second substrate 20 opposite the OCB mode LC 18. The OCB mode LCD may further include an upper compensation film 16, between the first substrate 10 and the upper polarizer 14, and a lower compensation film 20, between the second substrate 12 and the lower polarizer 23, to compensate for a viewing angle by delaying a phase of incident light. Alignment layers of the first substrate 10 and the second substrate 12 may be aligned in the same direction.

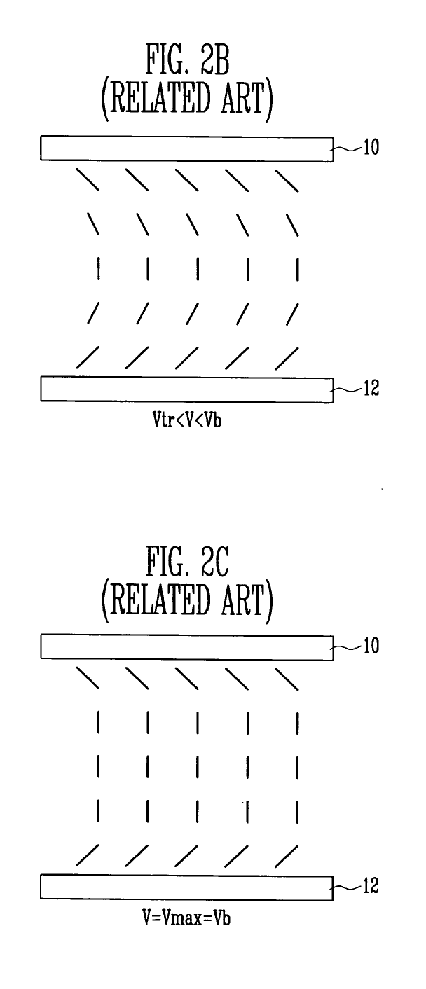

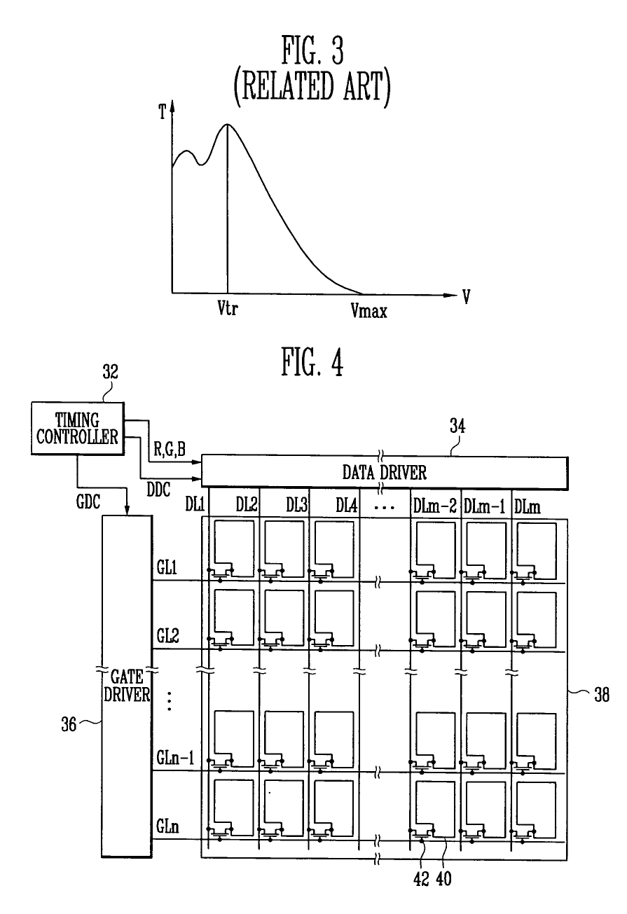

FIG. 2A to FIG. 2C illustrate alignment in an OCB mode LC depending on a voltage applied to the OCB mode LCD of FIG. 1, and FIG. 3 illustrates optical transmittance depending on a voltage applied to the OCB mode LCD of FIG. 1.

When a voltage below a transition voltage (Vtr) is applied to the OCB mode LCD, the OCB mode LC between the first substrate 10 and the second substrate 12 may maintain a splay state, i.e., an initial alignment state, as shown in FIG. 2A, depending on an alignment direction of the alignment layers. That is to say, the LC compounds may be arranged at a tilt angle of θ and −θ° in the surfaces of the upper/lower alignment layers, respectively, and the tilt angle may decrease as the LC compounds approach a central region of a LC cell. Therefore, a tilt angle of the LC compounds may become 0° in the center of the LC cell.

As can be seen in FIG. 3, when a voltage (V) less than the the transition voltage (Vtr) is applied to the OCB mode LCD, i.e., the OCB mode LC is in the splay state, transmittance may fluctuate, since changing the voltage may non-linearly change the transmittance. Therefore, spots or flickers may appear in an image for a short period by the LCs in a splay state.

When a voltage (V) greater than transition voltage (Vtr), but less than a black voltage (Vb, is applied to the OCB mode LC, the LC may transition from the splay state into a white bend state, as shown in FIG. 2B. A time for transitioning LC from the splay state to the bend state is referred to as a transition time.

When the black voltage (Vb) is applied to the OCB mode LC, the LC compounds having a white bend state may transition into a black bend state, as shown in FIG. 2C. As can be seen in FIG. 3, when in the black bend state, the OCB mode LC has substantially zero transmittance.

The LC compounds in the white bend state may have a tilt angle of ±θ (herein, θ ranges from 5 to 15° in general), which is a reset pretilt angle value of the upper/lower alignment layers. The tilt angle may increase as the LC compounds approach a central region of the LC cell. Therefore, a tilt angle of the LC compounds may approach 90° in the center of the LC cell.

As can be seen in FIG. 3, the LC in the white bend state may have an optical transmittance that decreases linearly as a voltage (V) increases. That is to say, the LC in the white bend may be suitable for realizing a grayscale and, thus, may be used for realizing an image.

In such an OCB mode LCD, time required for rearrangement of the LC compounds, i.e., a response time, may be very rapid, e.g., within a range of about 5 msec, since the LC compounds move swiftly when the LC is in the white bend state and a predetermined voltage is applied. Accordingly, the LC in the white bend state may have a high-speed response characteristic. Therefore, LCs in the white bend state have been widely used for realizing a moving picture, since residual images hardly remain.

However, even when the OCB mode LC cells have been transitioned to the white bend state, if a voltage applied to the OCB mode LC cells is below the transition voltage (Vtr), the OCB mode LC cells may return to a splay state. An image signal for such an OCB mode LCD may have a limited amplitude, since a suitable voltage for maintaining the white bend state, i.e., a voltage above a transition voltage (Vtr), may always be applied to OCB mode LC cells.

In other words, the OCB mode LCD may not perform the initial transition quickly enough, may not provide uniform optical characteristics, and/or may not provide a stable white bend state.

Accordingly, embodiments of the present invention may provide an OCB mode LCD having an improved optical transmittance, uniform optical characteristics and/or white bend state stability. An impulse driving method for use with such an OCB mode LCD may apply a high voltage during a predetermined time within one frame period, followed by applying a corresponding data signal. Such a configuration may allow a small form factor to be realized, thus allowing the LCD in accordance with embodiments of the present invention to be used for realizing a small screen, e.g., for use in mobile devices, etc.,

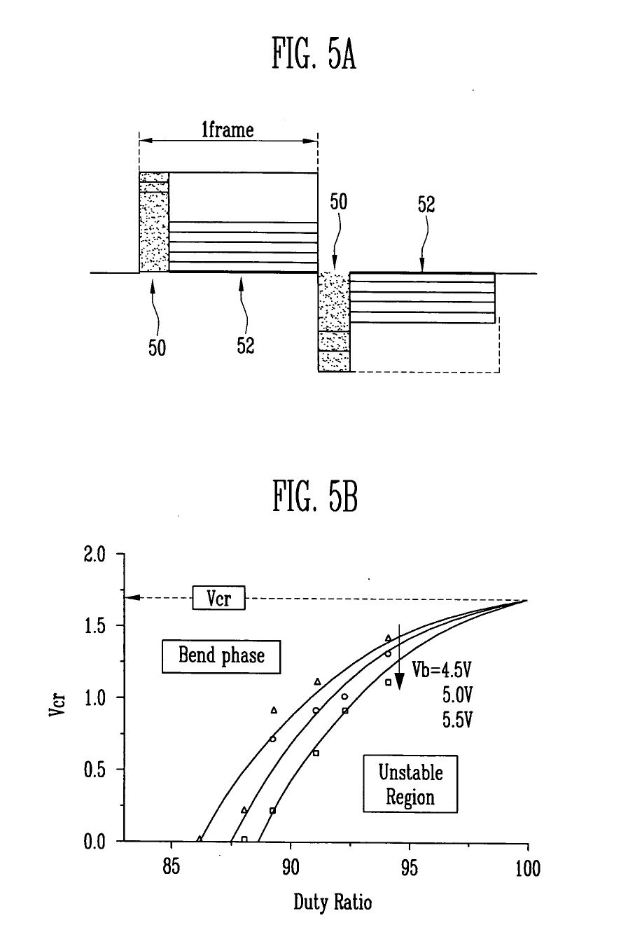

FIG. 4 illustrates a block view of a configuration of an OCB mode LCD according to an embodiment of the present invention.

Referring to FIG. 4, the OCB mode LCD according to one embodiment of the present invention may include an LCD panel 38, a data driver 34 for supplying a video data to data lines (DL) of the LCD panel 38, a gate driver 36 for sequentially driving gate lines (GL) of the LCD panel 38, and a timing controller 32 for controlling the data driver 34 and the gate driver 36.

While the data driver 34 and the gate driver 36 may be separate, as shown in FIG. 4, they may be integrated into a single integrated circuit (IC), e.g., in a chip-on-panel (COP). That is to say, the OCB mode LCD according to an embodiment of the present invention may include a small LCD provided in mobile devices, etc., but the data driver and the gate driver are illustrates as separate to simplify their description.

The timing controller 32 may generate control signals (GDC, DDC) for controlling the gate driver 36 and the data driver 34, and may supply pixel data signals (R, G, B) to the data driver 34. Gate control signals (GDC) generated in the timing controller 32 may include a gate start pulse (GSP), a gate shift clock signal (GSC), a gate output enable signal (GOE), etc. The data control signals (DDC) generated in the timing controller 32 may include a source start pulse (SSP), a source shift clock signal (SSC), a source output enable signal (SOE), a polar control signal (POL), etc. Here, the polar control signal (POL) may reverse a polarity of the data signal, depending on a dot inversion system, a line inversion system, a column inversion system and a frame inversion system.

The gate driver 36 may sequentially supply the scan signal to gate lines (GL1 to GLn) using the gate control signals (GDC). Therefore, the gate driver 36 may drive a thin film transistor (TFT) 42 in a horizontal line unit in response to the scan signal.

The data driver 34 may convert the input pixel data into an analog pixel signal to supply only a pixel signal of the first horizontal line to data lines (DL1 to DLm) in every first horizontal period when the scan signal is supplied to the gate line (GL). In this case, the data driver 34 may use gamma voltages, supplied from a gamma voltage generation unit (not shown), to convert the pixel data into the pixel signal.

The data driver 34 may supply different polarities of the pixel voltage signal to one of a dot inversion system, a line inversion system, a column inversion system and a frame inversion system.

The LCD panel 38 may include a TFT 42 at intersections between the gate lines (GL1 to GLn) and the data lines (DL1 to DLm), and a pixel electrode 40 for each LC cell. The TFT 42 may supply the pixel voltage signal, supplied from the data lines (DL1 to DLm), to the pixel electrode 40 in response to the scan signal supplied from the gate line (GL). The pixel electrode 40 may control an optical transmittance by driving an OCB mode liquid crystal arranged between the pixel electrode 40 and a common electrode (not shown) in response to the pixel voltage signal.

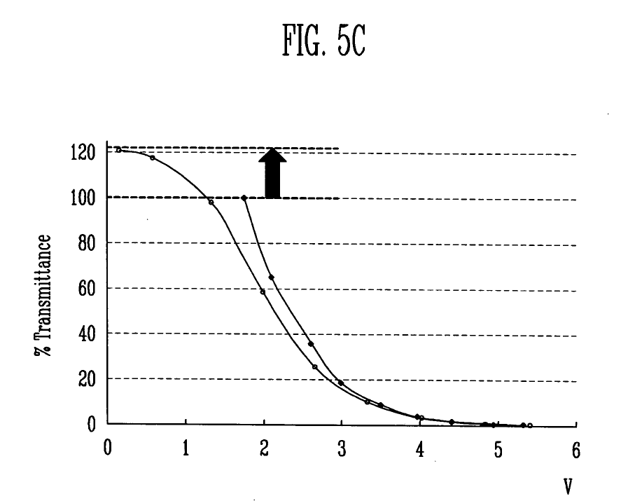

FIG. 5A illustrates a method for driving the OCB mode LCD of FIG. 4 according to an embodiment of the present invention. FIG. 5B illustrates a relationship between an amplitude of an impulse voltage used in the driving method of FIG. 5A and a critical voltage (Vcr). FIG. 5C illustrates increased transmittance that may be realized using the driving method of FIG. 5A as compared with a conventional driving method.

As can be seen in FIG. 5A, when a predetermined pixel signal is supplied to a data line, rather than applying the pixel signal, an impulse voltage having the black value (Vb) or higher voltages may be initially applied as an impulse signal for a predetermined period within the first frame period. After this predetermined period, the pixel signal may then be applied for the remainder of the first frame period. In other words, the LCD according to the present invention may be driven by allotting an impulse signal, rather than a corresponding pixel signal, to the predetermined period in one frame unit in order to prevent an image in the previous frame from affecting an image in an existing frame. The predetermined period may be maintained within a range of about 10˜20% of one frame period.

In detail, as shown in FIG. 5A, first, rather than a pixel signal 52, an impulse signal 50, i.e., an impulse voltage that is equal to or greater than the black voltage (Vb), may be applied to every frame for the predetermined period within the frame period. Then, the pixel signal 52 may be applied for a remainder of the frame period. When the LCD is driven in an inversion manner, signals applied to alternating frames are inverted, as shown in FIG. 5A.

The predetermined period in which the impulse signal 50 is applied may range from about 10 to 20% of one frame, and may have a voltage of about 5˜8V or higher, e.g., within a range starting about the black voltage for the OCB mode LCD. When the above examples are satisfied, then optical characteristics and the bend state driving stability may be improved.

Thus, in the method for driving a LCD according to an embodiment of the present invention, a voltage level of the impulse signal, used when compared to a conventional impulse driving method, is not limited by a black voltage (Vb), but may be the black voltage (Vb) or higher voltages. Thus, luminance of the OCB mode LCD may be minimally reduced while using a shorter impulse period than in a conventional method. This may be of particular use for small OCB mode LCDs, e.g., for use in mobile devices, etc.

Accordingly, white bend state stability may be improved. Further, the optical transmittance may be further due to an increase of valid retardation by removing limits to a driving range of a voltage which may arise due to the existence of an OCB mode LC specific voltage.

Optical transmittance may be of particular importance to displays having highly limited power consumption requirement, e.g., displays used in mobile devices. Further, since importance of white bend state stability increases as a possibility of external impacts or other interferences increase, the driving method according to an embodiment of the present invention may be applied to displays used in mobile devices.

The graph in FIG. 5B is a plot of the percentage of time during a frame period in which the pixel signal is applied versus a critical voltage (Vcr). The critical voltage (Vcr) indicated by the dashed line is a value when no impulse signal is applied. As can be in FIG. 5, as a voltage level of the applied impulse signal, starting with the black voltage Vb, is increased, less time within the frame is needed to lower the critical voltage. Thus, an impulse signal time in which the limitation to the critical voltage (Vcr) may be completely removed, e.g., driving the critical voltage (Vcr) to zero, may be decreased.

The graph in FIG. 5C is a plot voltage versus transmittance (V-T), where the V-T curve resulting from the driving method in accordance with an embodiment of the present invention is indicated by “∘” and from a conventional driving method is indicated by“♦.” As can be seen in FIG. 5C, a range of the apparent driving voltages may be extended down to about 0V using the driving method of FIG. 5A. Thus, there is no margin for the critical voltage (Vcr). Therefore, white bend state stability may be improved.

Further, the optical transmittance may be improved due to an increase of the actual transmittance, where the percent transmittance may be relative to the transmittance realized from the conventional method.

As described above, according to an embodiment of the present invention, driving of the LCD may include applying a high voltage during a predetermined time within one frame period, followed by applying a corresponding data signal. Thus, the LCD according to an embodiment of the present invention may improve an optical transmittance of the OCB mode LCD itself, and may increase white bend state stability. Thus, the LCD may be used in mobile devices, etc.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A liquid crystal display (LCD), comprising:
a LCD panel including a plurality of optically compensated birefringence (OCB) mode liquid crystal (LC) cells, each OCB mode LC cell being associated with a gate line and a data line; and
a LCD panel driver for applying an impulse voltage for a predetermined period within a first frame period when a pixel signal is supplied to the OCB mode LC cell, wherein the impulse voltage is equal to or greater than a black voltage for the OCB mode LC, and for applying, after the predetermine period, the pixel signal to the OCB mode LC.

2. The LCD as claimed in claim 1, wherein the LCD panel driver comprises:
a gate driver for sequentially driving gate lines; and
a data driver for applying the impulse voltage for the predetermined period within the first frame period and applying the pixel signal, after the predetermined period, to data lines.

3. The LCD as claimed in claim 2, wherein the data driver and the gate driver are formed in a form of chip-on-panel composed of one integrated circuit.

4. The LCD as claimed in claim 1, wherein the LCD is a small OCB mode LCD provided in a mobile device.

5. The LCD as claimed in claim 1, wherein the predetermined period is about 10˜20% of the first frame period.

6. The LCD as claimed in claim 1, wherein the impulse voltage is about 5˜8V or higher.

7. The LCD as claimed in claim 1, wherein a critical voltage of the OCB mode LC cell is about zero.

8. A method for driving a liquid crystal display (LCD) panel having a plurality of optically compensated birefringence (OCB) mode liquid crystal (LC) cells, each OCB mode LC cell being associated with a gate line and a data line, the method comprising:
applying an impulse voltage for a predetermined period within a first frame period when a pixel signal is supplied to the OCB mode LC cell, the impulse voltage being equal to or greater than a black voltage for the OCB mode LC; and
applying the pixel signal after the predetermined period.

9. The method for driving a LCD as claimed in claim 8, further comprising:
sequentially driving gate lines via a gate driver, wherein applying the impulse voltage for the predetermined period within the first frame period and applying the pixel signal is to data lines via a data driver.

10. The method for driving a LCD as claimed in claim 9, wherein the data driver and the gate driver are formed as a chip-on-panel composed of one integrated circuit.

11. The method for driving a LCD as claimed in claim 8, wherein the predetermined period is about 10˜20% of the first frame.

12. The method for driving a LCD as claimed in claim 8, wherein the impulse voltage is at least about 5˜8V.

13. The method for driving a LCD as claimed in claim 8, wherein a critical voltage of the OCB mode LC cell is about zero.
